(19) United States
(12) Patent Application Publication
(10) Pub. No.: US 2019/0049891 A1
(43) Pub. Date: Feb. 14, 2019

(54) SHEET TRANSPORT DEVICE AND IMAGE FORMING APPARATUS

(71) Applicant: FUJI XEROX CO., LTD., Tokyo (JP)

(72) Inventor: Kazuaki IIKURA, Kanagawa (JP)

(73) Assignee: FUJI XEROX CO., LTD., Tokyo (JP)

(21) Appl. No.: 15/915,724

(22) Filed: Mar. 8, 2018

(30) Foreign Application Priority Data
Aug. 10, 2017 (JP) 2017-155725

(51) Int. Cl. G03G 15/00; G03G 15/20; G03G 21/16

(52) U.S. Cl. CPC G03G 15/6529; G03G 2221/1675; G03G 21/1633; G03G 15/2085

(57) ABSTRACT

A sheet transport device includes: a transport part that transports a sheet along a transport path; a sheet guide that forms the transport path when located at a first position and that exposes the sheet in the transport path when located at the second position; a housing that accommodates the transport part and the sheet guide; a cover provided on the housing, the cover being capable of being opened and closed and being provided at a position where the cover covers the sheet guide; and a pulling member that is connected at one end to the cover and at the other end to the sheet guide located at the first position when the cover is closed, the pulling member pulling the sheet guide to the second position when the cover is opened.

### CROSS-REFERENCE TO RELATED APPLICATIONS

This application is based on and claims priority under 35 USC 119 from Japanese Patent Application No. 2017-155725 filed Aug. 10, 2017.

### BACKGROUND

### Technical Field

The present invention relates to sheet transport devices and image forming apparatuses.

### SUMMARY

According to an aspect of the invention, there is provided a sheet transport device including: a transport part that transports a sheet along a transport path; a sheet guide that forms the transport path when located at a first position and that exposes the sheet in the transport path when located at the second position; a housing that accommodates the transport part and the sheet guide; a cover provided on the housing, the cover being capable of being opened and closed and being provided at a position where the cover covers the sheet guide; and a pulling member that is connected at one end to the cover and at the other end to the sheet guide located at the first position when the cover is closed, the pulling member pulling the sheet guide to the second position when the cover is opened.

### BRIEF DESCRIPTION OF THE DRAWINGS

Exemplary embodiment of the present invention will be described in detail based on the following figure, wherein:

FIG. 1 shows the overall configuration of an image forming apparatus according to an exemplary embodiment;

FIG. 2 is an enlarged view of a fixing mechanism;

FIGS. 3A to 3F show the movements of components when a cover part is opened;

FIGS. 4A to 4F show the movements of the components when the cover part is closed; and

FIGS. 5A to 5F show the movement of a fixing mechanism according to a modification.

### DETAILED DESCRIPTION

### 1. Exemplary Embodiment

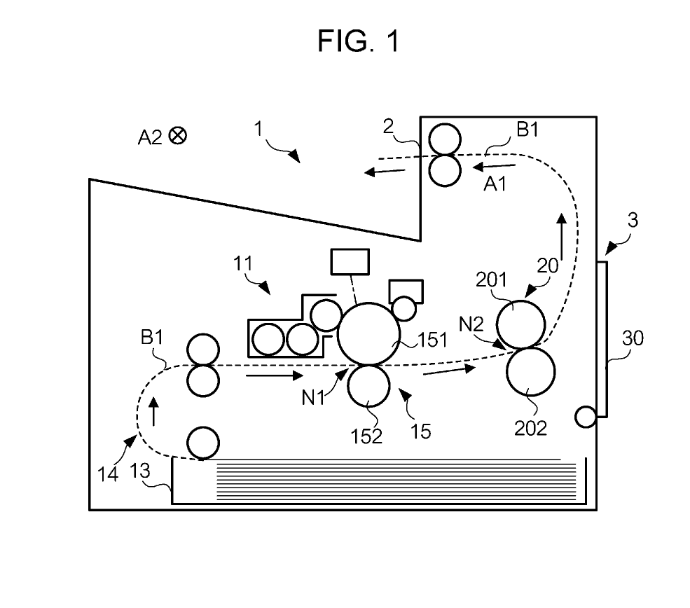

FIG. 1 shows the overall configuration of an image forming apparatus 1 according to an exemplary embodiment. The image forming apparatus 1 forms an image on a medium by using an electrophotographic system. The image forming apparatus 1 is connected to an external device by a communication line (not shown). The image forming apparatus 1 forms an image by processing image data transmitted from the external device and fixing toner to a sheet. The image forming apparatus 1 includes a toner-image developing mechanism 11, a paper feed mechanism 13, a transport mechanism 14, a transfer mechanism 15, a fixing mechanism 20, and a housing 2 for accommodating these mechanisms.

The toner-image developing mechanism 11 forms an image represented by the image data by forming a toner image on an image bearing member 151. The paper feed mechanism 13 stores sheets on which images are formed and feeds the sheets to the transport mechanism 14. The transport mechanism 14 includes multiple rollers and transports a sheet among the respective mechanisms (i.e., the paper feed mechanism 13, the transfer mechanism 15, and the fixing mechanism 20) of the image forming apparatus 1 in a transport direction A1, along a transport path B1. Hence, the sheet transported by the transport mechanism 14 sequentially passes the transfer mechanism 15 and the fixing mechanism 20. The transport mechanism 14 is an example of a “transport part” of the present invention.

The transfer mechanism 15 includes the image bearing member 151 and a transfer roller 152, which rotate about the rotation shafts. The image bearing member 151 and the transfer roller 152 are pressed against each other, forming a nip area N1 therebetween, through which a sheet passes. When a transfer voltage is applied between the transfer roller 152 and the image bearing member 151, the image held on the image bearing member 151 is transferred to the sheet passing through the nip area N1.

The fixing mechanism 20 includes a heating roller 201 and a pressure roller 202, which rotate about the rotation shafts. The heating roller 201 and the pressure roller 202 form a nip area N2 at which the sheet is nipped. The heating roller 201 is a heat-generating rotary member and is an example of a “first rotary member” of the present invention. The pressure roller 202 is a rotary member that rotates with the heating roller 201 to transport the sheet nipped at the nip area N2. The pressure roller 202 is an example of a “second rotary member” of the present invention.

The fixing mechanism 20 fixes the image to the sheet by applying, with the heating roller 201 and the pressure roller 202, heat and pressure to the sheet to which the image has been transferred. The fixing mechanism 20 is a unit and can be removed from the housing 2. FIG. 1 shows the image forming apparatus 1 as viewed in a rotation-axis direction A2, which is the direction from the near side to the far side, of the directions parallel to the rotation shafts of the heating roller 201 and the pressure roller 202. The sheet to which the image has been fixed by the fixing mechanism 20 is discharged to the outside of the image forming apparatus 1 by the transport mechanism 14.

As described above, in the image forming apparatus 1, the sheet is transported along the transport path B1 by the paper feed mechanism 13, the transport mechanism 14, the transfer mechanism 15, and the fixing mechanism 20. The image forming apparatus 1 including these mechanisms is an example of a “sheet transport device” of the present invention. Furthermore, an image is formed on the transported sheet by the toner-image developing mechanism 11, the transfer mechanism 15, and the fixing mechanism 20. These mechanisms are an example of an “image forming part” of the present invention.

The housing 2 has an opening 3 near the fixing mechanism 20. In the case of a trouble, such as a paper jam occurring in the fixing mechanism 20, the jammed sheet is removed from the opening 3, or the fixing mechanism 20 is removed. The image forming apparatus 1 has a cover mechanism 30 for covering the opening 3.

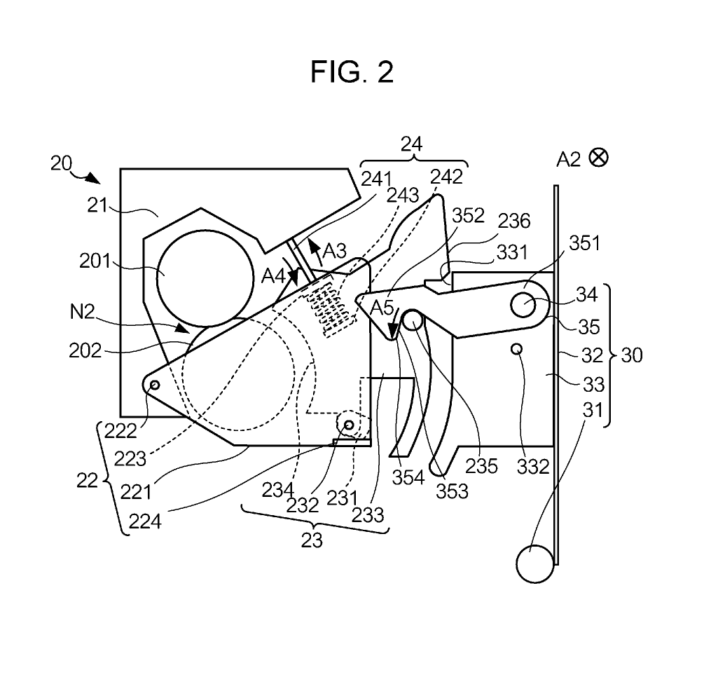

Opening the cover mechanism 30 not only exposes the opening 3, but also brings the fixing mechanism 20 to a state in which the jammed sheet can be easily removed. The structure for achieving such a state will be described with reference to FIGS. 2 to 5F.

FIG. 2 is an enlarged view of the fixing mechanism 20 and the cover mechanism 30. The fixing mechanism 20 includes, besides the heating roller 201 and the pressure roller 202, a frame 21, pressure adjusting parts 22, a sheet guide part 23, and urging parts 24.

The frame 21 is a frame for the fixing mechanism 20 and supports the components of the fixing mechanism 20 attached thereto. The pressure adjusting parts 22 support the pressure roller 202 so as to allow rotation thereof and adjust the pressure applied to the nip area N2. The pressure adjusting parts 22 are provided at the ends of the pressure roller 202. The sheet guide part 23 is disposed so as to face the outer circumferential surface of the pressure roller 202, forming a transport path therebetween. The urging parts 24, provided so as to correspond to the two pressure adjusting parts 22, urge the pressure adjusting parts 22 toward the frame 21 to generate a pressure applied to the nip area N2.

The pressure adjusting parts 22 include plate parts 221, a rotation shaft 222, urging-force receiving parts 223, and repelling-force receiving parts 224. The sheet guide part 23 includes cam parts 231, a rotation shaft 232, and a body part 233. The urging parts 24 each include a support rod 241, a spring support part 242, and a coil spring 243. The cover mechanism 30 includes a rotation shaft 31, a cover part 32, a support part 33, fulcrum parts 34, and hook parts 35.

The rotation shaft 222 is inserted into and fixed to the frame 21 and supports the plate parts 221 so as to allow rotation thereof. The plate parts 221, to which the rotation shaft of the pressure roller 202 is attached, support the pressure roller 202 so as to allow rotation thereof. When the plate parts 221 are rotated about the rotation shaft 222, the pressure roller 202 is pressed against the heating roller 201 (at this time, the pressure roller 202 moves in a pressure direction A3), or the pressure roller 202 is separated from the heating roller 201 (at this time, the pressure roller 202 moves in a separating direction A4). FIG. 2 shows a state in which the pressure roller 202 is pressed against the heating roller 201, forming the nip area N2.

The urging-force receiving parts 223 and the repelling-force receiving parts 224 are fixed to the plate parts 221. The urging-force receiving parts 223 receive an urging force in the pressure direction A3 from the urging parts 24. More specifically, first ends of the support rods 241 of the urging parts 24 are fixed to the frame 21, and second ends of the support rods 241 of the urging parts 24 are fixed to the spring support parts 242. The urging-force receiving parts 223 have holes, through which the support rods 241 pass.

The coil springs 243 are disposed between the urging-force receiving parts 223 and the spring support parts 242 in a compressed state. When the coil springs 243 try to expand and apply a force to the urging-force receiving parts 223, the plate parts 221 rotate in the pressure direction A3, pressing the pressure roller 202 against the heating roller 201. As described, the pressure adjusting parts 22 support the pressure roller 202 while urging it toward the heating roller 201. The pressure adjusting parts 22 are an example of a “support member” of the present invention.

The repelling-force receiving parts 224 receive a repelling force applied from the sheet guide part 23. The repelling force is applied to repel the pressure roller 202. More specifically, the repelling force rotates the plate parts 221 in the separating direction A4. The repelling-force receiving parts 224 receive the repelling force from the cam parts 231 of the sheet guide part 23. The cam parts 231 are provided so as to rotate about the rotation shaft 232. When the cam parts 231 rotate, they come into contact with the repelling-force receiving parts 224 and apply a force (repelling force) to move the repelling-force receiving parts 224 in the separating direction A4.

The rotation shaft 232 of the sheet guide part 23 is supported by the frame 21 so as to allow rotation thereof. The cam parts 231 and the body part 233 are fixed to the rotation shaft 232, and, when the rotation shaft 232 rotates, the cam parts 231 and the body part 233 also rotate. The image forming apparatus 1 has a stopper (not shown), and the body part 233 rotates to a position where it comes into contact with the stopper. The body part 233 includes a guide surface 234, receiving parts 235, and a contact part 236.

The guide surface 234 is curved along the outer circumferential surface of the pressure roller 202, and, when the sheet guide part 23 is located at a position shown in FIG. 2 (i.e., a “closed position”), forms the transport path B1 between itself and the outer circumferential surface of the pressure roller 202. When the body part 233 rotates to the position where it comes into contact with the stopper, the guide surface 234 is separated from the outer circumferential surface of the pressure roller 202, exposing a sheet in the transport path B1. The position of the sheet guide part 23 at this time is an “open position”.

The closed position is an example of a “first position” of the present invention, and the open position is an example of a “second position” of the present invention. The sheet guide part 23 having the guide surface 234 is an example of a “sheet guide” of the present invention. When the cam parts 231 of the sheet guide part 23 come into contact with the pressure adjusting parts 22 to move the sheet guide part 23 from the closed position to the open position, the cam parts 231 apply a repelling force to the repelling-force receiving parts 224 to move the pressure adjusting parts 22 in the separating direction A4. The cam parts 231 are an example of a “moving member” of the present invention.

The receiving parts 235 are projections provided at the end of the body part 233 in the rotation-axis direction A2 and at the end of the body part 233 in the direction opposite to the rotation-axis direction A2. The receiving parts 235 receive hook parts 35 (described below) provided on the cover mechanism 30. The rotation shaft 31 of the cover mechanism 30 is supported on the housing 2 so as to allow rotation thereof. The cover part 32, which is provided at a position where it covers the sheet guide part 23, is fixed to the rotation shaft 31 and rotates about the rotation shaft 31. The cover part 32 is plate-shaped and has a size capable of covering the opening 3 shown in FIG. 1. At the position shown in FIG. 2, the cover part 32 closes the opening 3. The cover part 32 is an openable cover provided on the housing 2 and is an example of a “cover” of the present invention.

The support part 33 is fixed to a portion of the cover part 32 inside the housing 2. The support part 33 supports the fulcrum parts 34 so as to allow rotation thereof. The hook parts 35 each have a claw-shaped portion at one end 352. The other end 351 of the hook part 35 is fixed to the fulcrum part 34. Thus, the hook parts 35 are connected to the cover part 32 via the support part 33. The hook parts 35 rotate about the fulcrum parts 34. When the cover part 32 is closed, the claw-shaped ends 352 of the hook parts 35 are engaged with the receiving parts 235, and the hook parts 35 are connected to the sheet guide part 23 located at the closed position.

When the cover part 32 is opened, the hook parts 35 pull the sheet guide part 23 to the open position. The hook parts 35 are an example of a “hook” and a “pulling member” of the present invention. The ends 351 are an example of “one end” of the present invention, and the ends 352 are an example of “the other end” of the present invention. The hook parts 35 are urged in a bending direction A5, in which the claw-shaped ends 352 are bent, by torsion springs (not shown). The support part 33 has restricting parts 332 that restrict the rotation of the hook parts 35 urged in the bending direction A5. The restricting parts 332 are an example of a “restricting member” of the present invention.

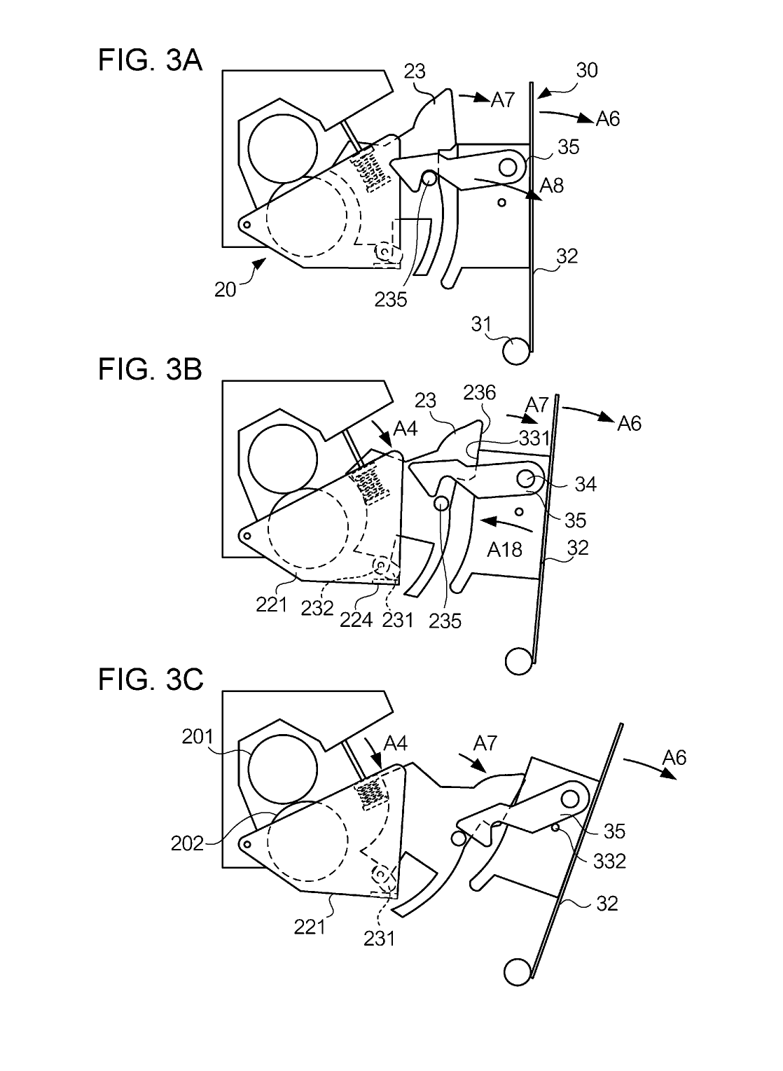

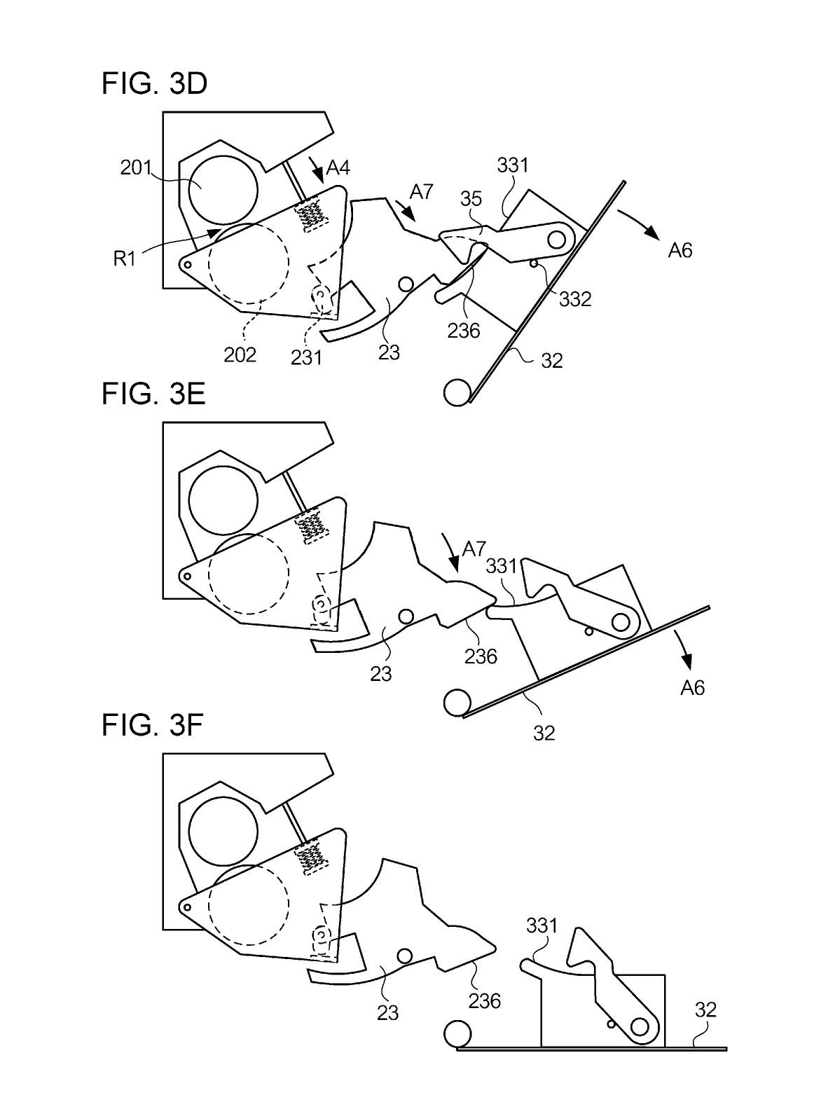

When the sheet guide part 23 moves to the open position, the contact part 236 of the body part 233 comes into contact with a contact part 331 of the support part 33 of the cover mechanism 30. This configuration allows the sheet guide part 23 to move to the open position not abruptly by being pulled by the gravity but slowly while being supported by the cover mechanism 30. The movements of the components when the cover part 32 is opened will be described with reference to FIGS. 3A to 3F.

FIGS. 3A to 3F show the movements of the components when the cover part 32 is opened. FIG. 3A shows the fixing mechanism 20 and the cover mechanism 30 in the same state as in FIG. 2. When a user starts to open the cover part 32 in this state, the cover part 32 starts to move in an open direction A6 about the rotation shaft 31. At the same time, the sheet guide part 23 pulled by the hook parts 35 via the receiving parts 235 starts to move in an open direction A7.

FIG. 3B shows a state in which the cover part 32 is slightly open (i.e., a state in which the cover part 32 has been rotated in the open direction A6). When the sheet guide part 23 further moves in the open direction A7, the cam parts 231 rotate, applying a force to the repelling-force receiving parts 224. As a result, the plate parts 221 start to rotate in the separating direction A4. When the cover part 32 moves in the open direction A6, the distance between the receiving parts 235 and the fulcrum parts 34 increases, and the claw-shaped ends 352 of the hook parts 35 are disengaged from the receiving parts 235.

Even after the hook parts 35 are disengaged from the receiving parts 235, because the center of gravity of the sheet guide part 23 is located farther than the rotation shaft 232 in the open direction A7, the sheet guide part 23 tends to rotate in the open direction A7 due to its own weight. However, the contact part 236 comes into contact with the contact part 331 of the cover mechanism 30 and supports the weight of the sheet guide part 23.

FIG. 3C shows a state in which the cover part 32 is slightly more open than that in FIG. 3B. In this state, the cam parts 231 have further rotated, and the plate parts 221 have further rotated in separating direction A4. As a result, the pressure roller 202 and the heating roller 201, which were pressing each other, are in a state in which the pressure roller 202 and the heating roller 201 are in slight contact each other. The hook parts 35 are completely disengaged from the receiving parts 235.

As described, when the cover part 32 is opened, the hook parts 35 move in the moving direction A8 together with the cover part 32 and are disengaged from the receiving parts 235 while the sheet guide part 23 moves from the closed position to the open position. This mechanism will be described in detail below. The hook parts 35 have contact parts 353 (see FIG. 2) that come into contact with the receiving parts 235 while the cover part 32 is opened. The contact parts 353 are an example of a “first contact part” of the present invention.

Distal end portions 354, which are located at the extreme distal ends of the contact parts 353, are located farther than the other portions of the contact parts 353 in the direction A18, which is opposite to the moving direction A8. Hence, when the hook parts 35 move in the moving direction A8, portions of the contact parts 353 in contact with the receiving parts 235 move toward the distal end portions 354, as shown in FIG. 3B, and are disengaged from the receiving parts 235, as shown in FIG. 3C, at some point.

FIG. 3D shows a state in which the cover part 32 is slightly more open than that in FIG. 3C. In this state, the cam parts 231 have further rotated, and the plate parts 221 have further rotated in the separating direction A4, and the pressure roller 202 and the heating roller 201 are completely separated with a gap R1 therebetween. The sheet guide part 23 gradually rotates in the open direction A7 with the contact part 236 still being in contact with and supported by the contact part 331 of the cover mechanism 30. The hook parts 35 come into contact with the restricting parts 332 and are prevented from rotating any further.

FIG. 3E shows a state in which the cover part 32 is slightly more open than that in FIG. 3D. In this state, the contact part 236 of the sheet guide part 23 is still in contact with and is supported by the contact part 331 of the cover mechanism 30. FIG. 3F shows a state in which the cover part 32 is fully open. The cover part 32 comes into contact with a stopper (not shown) and is prevented from opening any further.

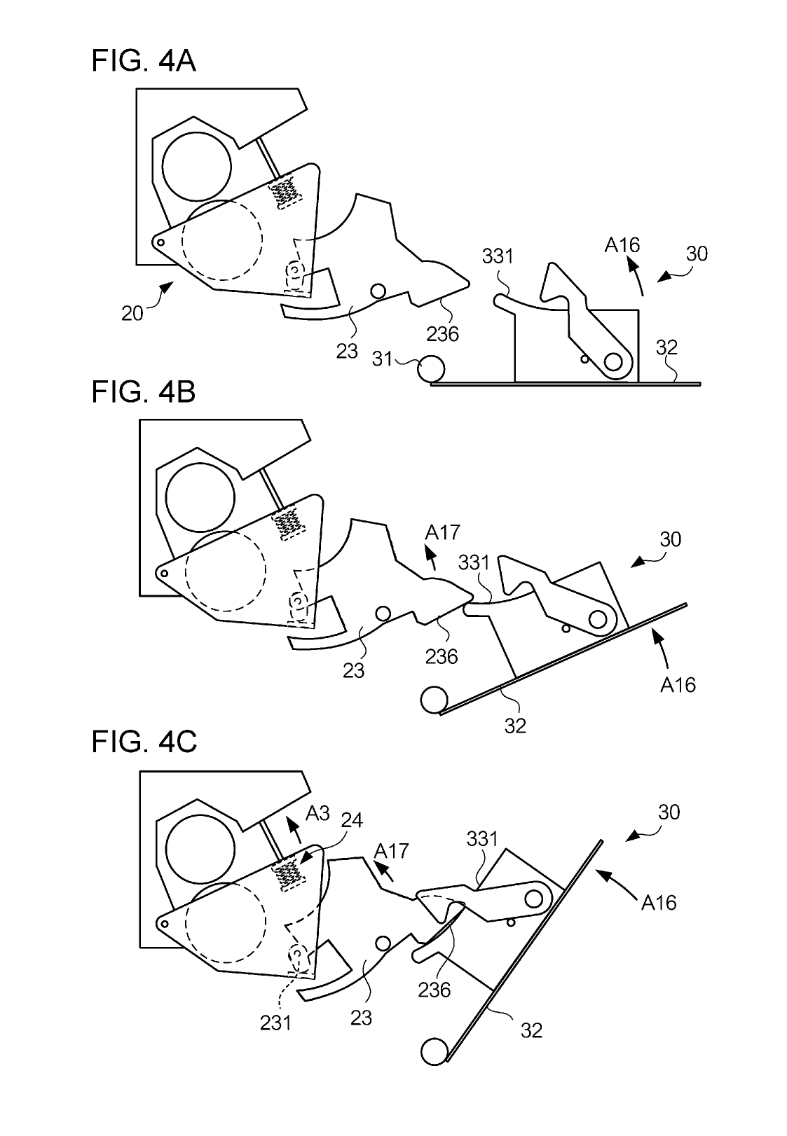

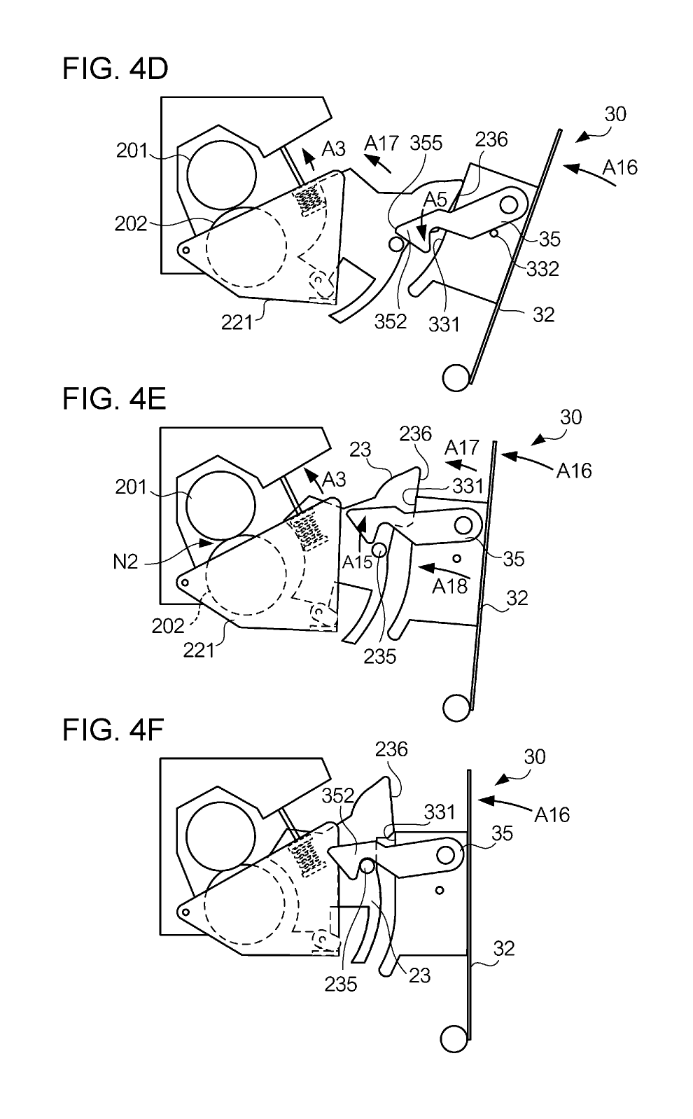

In this state, the contact part 236 of the sheet guide part 23 is not in contact with the contact part 331 of the cover mechanism 30, and the sheet guide part 23 is in contact with the stopper and is stopped, that is, the sheet guide part 23 has been rotated to a stop position. As described, the support part 33 having the contact part 331 stops being in contact with the sheet guide part 23 while the sheet guide part 23 moves from the closed position to the open position. The movements of the components when the cover part 32 is closed will be described with reference to FIGS. 4A to 4F.

FIGS. 4A to 4F show the movements of the components when the cover part 32 is closed. FIG. 4A shows the fixing mechanism 20 and the cover mechanism 30 in the same state as in FIG. 3F. In this state, when the user starts to close the cover part 32, the cover part 32 starts to move about the rotation shaft 31 in a closing direction A16. FIG. 4B shows a state in which the cover part 32 is slightly more closed (rotated in the closing direction A16) than that in FIG. 4A.

Although the contact part 236 of the sheet guide part 23 and the contact part 331 of the cover mechanism 30 are not in contact with each other in FIG. 4A, they are in contact with each other, and the sheet guide part 23 pushed by the cover mechanism 30 starts to rotate in a closing direction A17 in FIG. 4B. FIG. 4C shows a state in which the cover part 32 is slightly more closed than that in FIG. 4B. The sheet guide part 23 continues to rotate in the closing direction A17 with the contact part 236 thereof being in contact with the contact part 331 of the cover mechanism 30. As a result, the cam parts 231 start to return to the initial position, and the plate parts 221 urged by the urging parts 24 starts to rotate in the pressure direction A3.

FIG. 4D shows a state in which the cover part 32 is slightly more closed than that in FIG. 4C. In this state, the plate parts 221 have rotated further in the pressure direction A3, and the pressure roller 202, which was separated from the heating roller 201, has been moved in the pressure direction A3 until it is in contact with the heating roller 201. The claw-shaped ends 352 of the hook parts 35 are in contact with the receiving parts 235. The claw-shaped ends 352 are tapered toward distal ends 355, and portions thereof farther than the distal ends 355 in the bending direction A5 are in contact with the receiving parts 235.

As described, when the cover part 32 is closed, the restricting parts 332 that restrict the rotation of the hook parts 35 restrict the positions of the ends 352 such that the distal ends 355 are located farther than the receiving parts 235 in a direction opposite to the bending direction A5 until the claw-shaped ends 352 come into contact with the receiving parts 235. FIG. 4E shows a state in which the cover part 32 is slightly more closed than that in FIG. 4D. In this state, the plate parts 221 have rotated further in the pressure direction A3, and the pressure roller 202 is pressed against the heating roller 201, forming the nip area N2.

As described above, the hook parts 35 are urged in the bending direction A5. However, as the hook parts 35 move in the direction A18 opposite to the direction A8, in which they move when opened, portions thereof farther than the distal ends 355 of the claw-shaped ends 352 in the bending direction A5 receive a force in the direction A15 opposite to the bending direction A5 from the receiving parts 235, and, as a result, the hook parts 35 rotate in the opposite direction A15. When the claw-shaped ends 352 go beyond the receiving parts 235, the claw-shaped ends 352 are engaged with the receiving parts 235 by the urging force, as shown in FIG. 4F.

FIG. 4F shows a state in which the cover part 32 is fully closed. In FIGS. 4D to 4F, the sheet guide part 23 is rotated in the closing direction A17 to the closed position with the contact part 236 being in contact with the contact part 331 of the cover mechanism 30. As described, when the cover part 32 is closed, the support part 33 having the contact part 331 comes into contact with the sheet guide part 23 located at the stop position and applies a force thereto in the closing direction A17, moving the sheet guide part 23 to the closed position. The support part 33 is an example of a “second contact part” of the present invention.

In this exemplary embodiment, when a user opens the cover part 32, the sheet guide part 23 pulled by the hook parts 35 moves to the open position. This eliminates the effort involved in changing the position of the sheet guide part 23 when the cover part 32 covering the movable sheet guide part 23 is opened and a sheet is removed. Furthermore, the cam parts 231, which rotate with the sheet guide part 23, move the pressure adjusting parts 22 in the separating direction A4 to separate the heating roller 201 and the pressure roller 202. This reduces the effort involved in making it easy to remove the sheet nipped between the heating roller 201 and the pressure roller 202, compared with a case where the sheet guide part 23 does not have the cam parts 231.

In this exemplary embodiment, the fixing mechanism 20 and the cover mechanism 30 are temporarily connected by the hook parts 35, and, when the cover part 32 is opened, they are disconnected. With this configuration, a unit serving as the sheet guide part 23 and detachable from the housing 2 is used as the fixing mechanism 20. In this exemplary embodiment, because the hook parts 35 are disengaged from the receiving parts 235 while the sheet guide part 23 moves from the closed position to the open position, the cover part 32 is widely opened, compared with a case where the hook parts 35 are not disengaged from the receiving parts 235.

In this exemplary embodiment, when the cover part 32 is closed, the positions of the ends 352 of the hook parts 35 are restricted such that the distal ends 355 of the hook parts 35 are located farther than the receiving parts 235 in the direction opposite to the bending direction A5. This configuration ensures that the hook parts 35 are engaged with the receiving parts 235 when the cover part 32 is closed.

In this exemplary embodiment, when the cover part 32 is closed, the support part 33 of the cover mechanism 30 comes into contact with the sheet guide part 23 and moves the sheet guide part 23 to the closed position. This reduces the effort involved in closing the cover part 32, compared with a case where the cover part 32 does not have the support part 33. Furthermore, when the cover part 32 is opened, the support part 33 stops being in contact with the sheet guide part 23 while the sheet guide part 23 moves from the closed position to the open position. Compared with a case where the sheet guide part 23 continues to be in contact with the support part 33 even after the sheet guide part 23 has moved to the closed position, this configuration reduces the occurrence of breakage due to their collision.

### 2. Modifications

The above-described exemplary embodiment of the present invention is merely an example, and it may be modified as below. The exemplary embodiment and modifications may be implemented in combination, if necessary.

### 2-1 Duration of Contact between Sheet Guide Part and Cover Mechanism

The duration of contact between the sheet guide part and the cover mechanism when the cover part is opened may be different from that in the exemplary embodiment. Although the contact has continued to the position shown in FIG. 3E in the exemplary embodiment, the contact may end at, for example, a position shown in FIG. 3D or a position shown in FIG. 3C. In such cases, for example, the support part of the cover mechanism is shaped so as to stop in contact with the sheet guide part at these positions.

Furthermore, if, for example, the sheet guide part is sized and shaped so as not to collide with the cover mechanism when it is disengaged from the hook part and moves to the open position due to its own weight, the sheet guide part and the cover mechanism do not need to be in contact with each other. In that case, however, if no force is applied, the rotation shaft is subjected to an impact when the sheet guide part reaches the open position. Hence, it is desirable to provide a member for reducing the moving speed of the sheet guide part, such as a torsion spring.

### 2-2. Urging Sheet Guide Part

A member for urging the sheet guide part may be provided.

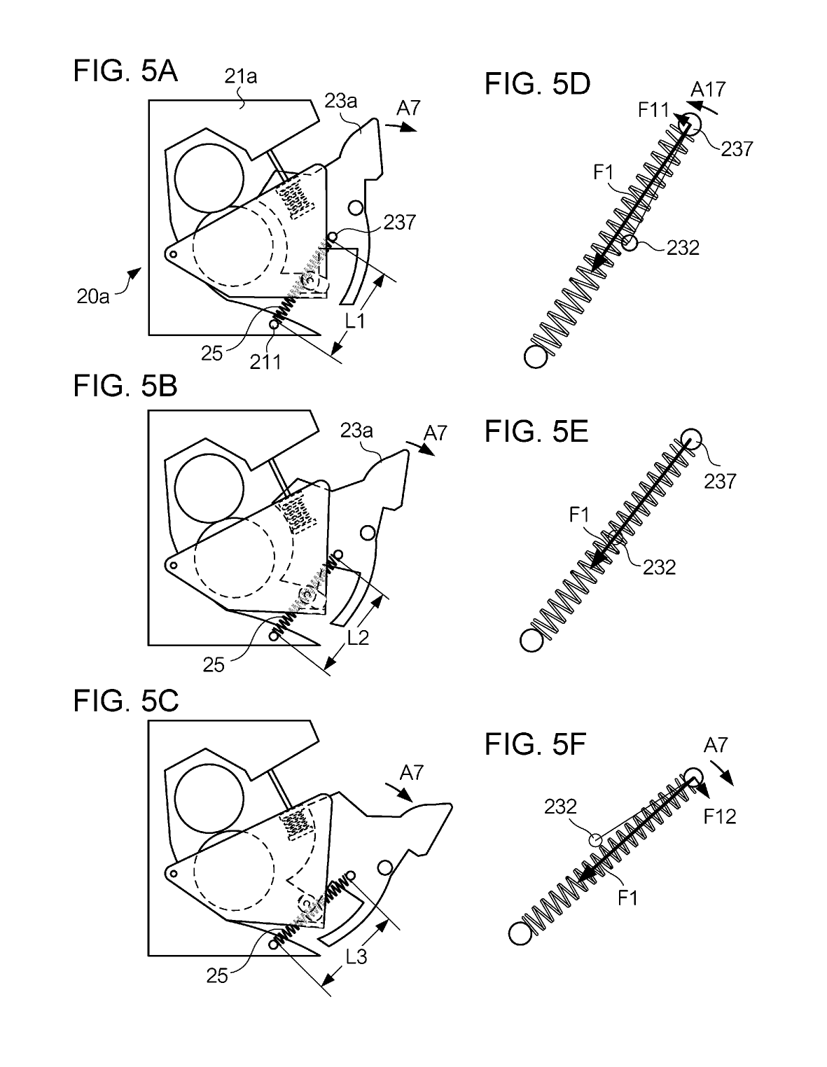

FIGS. 5A to 5F show a movement of the fixing mechanism 20a according to this modification. The fixing mechanism 20a includes a frame 21a and a sheet guide part 23a. The frame 21a has a spring fixing part 211, and the sheet guide part 23a has a spring fixing part 237. A coil spring 25 is fixed at one end to the spring fixing part 211 and at the other end to the spring fixing part 237.

FIG. 5A shows the sheet guide part 23a located at the closed position. FIG. 5B shows, similarly to FIG. 3B, the sheet guide part 23a located at a position where the claw-shaped ends 352 of the hook parts 35 are disengaged from the receiving parts 235 (this position is referred to as an “unhook position”). FIG. 5C shows, similarly to FIG. 3C, the sheet guide part 23a located at a position where the claw-shaped ends 352 of the hook parts 35 are completely disengaged from the receiving parts 235. FIGS. 5A to 5F do not show the cover mechanism 30 for the ease of understanding the drawings.

The coil spring 25 has a length of L1 at the closed position, a length of L2, which is largest, at the unhook position, and a length of L3 at a position shown in FIG. 5C (a position closer to the open position than the unhook position is). FIGS. 5D, 5E, and 5F are enlarged views of the coil spring 25 in FIGS. 5A, 5b, and 5C, respectively. As shown in FIG. 5E, the coil spring 25 is attached so as to overlap rotation shaft 232 of the sheet guide part 23a at the unhook position, where the coil spring 25 is longest.

When the coil spring 25 is located at the unhook position, a stress F1 of the coil spring 25 acts in a direction from the spring fixing part 237, which is the point of action of the stress F1, toward the rotation shaft 232. Thus, a component of force acting in a direction in which the sheet guide part 23a is rotated is not generated. Meanwhile, when the coil spring 25 is located at the closed position, as shown in FIG. 5D, because the direction of the stress F1 and the direction in which the rotation shaft 232 is located with respect to the spring fixing part 237 are shifted from each other, a component of force F11 acting in the closing direction A17 is generated. The sheet guide part 23a is urged in the closing direction A17 by the component of force F11.

When the coil spring 25 is located at a position closer to the open position than the unhook position is, as shown in FIG. 5F, because the direction of the stress F1 and the direction in which the rotation shaft 232 is located with respect to the spring fixing part 237 are shifted from each other, a component of force F12 acting in the open direction A7 is generated. The sheet guide part 23a is urged in the open direction A7 by the component of force F12.

As described, the coil spring 25 urges the sheet guide part 23a in the closing direction A17 (a direction from the open position to the closed position) when it is located at the closed position, and urges the sheet guide part 23a in the open direction A7 (a direction opposite to the closing direction A17) when it is located at a position closer to the open position than the unhook position (the position where the hook parts 35 are unhooked) is. The coil spring 25 is an example of a “first urging member” and a “second urging member” of the present invention. The closing direction A17 is an example of a “first direction” of the present invention, and the open direction A7 is an example of a “second direction” of the present invention. This configuration allows the sheet guide part 23a to move to the open position regardless of the gravity direction when the cover part 32 is opened, and allows the sheet guide part 23a to move to the closed position regardless of the gravity direction when the cover part 32 is closed.

### 2-3. Receiving Part

Although the projections provided on the sheet guide part 23 are used as the receiving parts in the exemplary embodiment, recesses or the like provided in the sheet guide part may alternatively be used as the receiving parts. In that case, the claw-shaped ends 352 of the hook parts 35 are engaged with the recesses. Although the receiving parts are provided on both ends of the sheet guide part 23 in the exemplary embodiment, it is also possible to provide only one receiving part (in that case, the receiving part is desirably provided in the middle in the rotation-axis direction A2) or to provide three or more receiving parts. As long as the hook parts 35 are engaged with the receiving parts to pull and move the sheet guide part, the receiving parts may be provided in any form.

### 2-4. Urging Member

Although the coil spring and the torsion spring are used as the urging members for urging the parts in the above-described embodiment and modification, other types of spring, an elastic member, such as a rubber member, an air-cylinder, or the like may also be used. Any urging members that can continuously apply a force in a predetermined direction to the parts may be used.

### 2-5 Position of The Cover Part

Although the cover part 32 is provided at a position where it covers the sheet guide part 23 of the fixing mechanism 20 in the exemplary embodiment, the cover part may be provided at a position where it covers the transfer mechanism 15. In that case, the cover part is opened when a sheet nipped between the image bearing member 151 and the transfer roller 152 is removed. Besides this, if a sheet guide that moves between a closed position and an open position is provided in the housing, the cover part is provided at a position where it covers the sheet guide.

### 2-6. Rotary Member

Although the rotary members of the fixing mechanism 20 are all rollers (cylindrical members) in the exemplary embodiment, the rotary members may be, for example, belts. It is only necessary that two rotary members form a nip area through which a sheet passes.

### 2-7. Pulling Member

Although the hook parts 35 are used as an example of the pulling member in the exemplary embodiment, for example, a rod-shaped member, an elastic member, or the like that is fixed at one end to the sheet guide part 23 and at the other end to the cover mechanism 30 may be used as the pulling member. For example, when a mechanism having a sheet guide (for example, a transfer mechanism) is fixed in the housing and cannot be taken out, because the pulling member does not need to be detached, the pulling member may be fixed, as in this modification.

### 2-8. Sheet Transport Device

Although the image forming apparatus 1 is an example of a “sheet transport device” according to the present invention in the exemplary embodiment, the example of the “sheet transport device” may also be, for example, a pretreatment device that is disposed before the image forming apparatus and performs pretreatment, such as coating, on a sheet or an aftertreatment device that is disposed after the image forming apparatus and performs aftertreatment, such as decurling, on a sheet. That is, any device that transports a sheet and allows a transport guide part to be moved to allow a sheet to be removed when a paper jam or other trouble occurs may be used as the sheet transport device.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet transport device comprising:
a transport part that transports a sheet along a transport path;
a sheet guide that forms the transport path when located at a first position and that exposes the sheet in the transport path when located at the second position;
a housing that accommodates the transport part and the sheet guide;
a cover provided on the housing, the cover being capable of being opened and closed and being provided at a position where the cover covers the sheet guide; and
a pulling member that is connected at one end to the cover and at the other end to the sheet guide located at the first position when the cover is closed, the pulling member pulling the sheet guide to the second position when the cover is opened.

2. The sheet transport device according to claim 1, wherein
the sheet guide includes a receiving part having a projection or a recess, and
the pulling member is a hook in which the other end is claw-shaped, the pulling member being connected to the sheet guide when the other end is engaged with the receiving part.

3. The sheet transport device according to claim 2, wherein the hook is disengaged from the receiving part while the sheet guide moves from the first position to the second position.

4. The sheet transport device according to claim 2, wherein
the hook has a first contact part to be in contact with the receiving part, and
a distal end portion of the first contact part, which is located at the extreme distal end of the first contact part, is located farther than the other portions of the first contact part in the direction opposite to the direction in which the hook moves when the cover is opened.

5. The sheet transport device according to claim 3, wherein
the hook has a first contact part to be in contact with the receiving part, and
a distal end portion of the first contact part, which is located at the extreme distal end of the first contact part, is located farther than the other portions of the first contact part in the direction opposite to the direction in which the hook moves when the cover is opened.

6. The sheet transport device according to claim 2, further comprising a first urging member that urges the sheet guide in a first direction, which is from the second position toward the first position, when the sheet guide is located at the first position and that urges the sheet guide in a second direction, which is opposite to the first direction, when the sheet guide is located at a position closer to the second position than the position where the hook is disengaged is.

7. The sheet transport device according to claim 3, further comprising a first urging member that urges the sheet guide in a first direction, which is from the second position toward the first position, when the sheet guide is located at the first position and that urges the sheet guide in a second direction, which is opposite to the first direction, when the sheet guide is located at a position closer to the second position than the position where the hook is disengaged is.

8. The sheet transport device according to claim 4, further comprising a first urging member that urges the sheet guide in a first direction, which is from the second position toward the first position, when the sheet guide is located at the first position and that urges the sheet guide in a second direction, which is opposite to the first direction, when the sheet guide is located at a position closer to the second position than the position where the hook is disengaged is.

9. The sheet transport device according to claim 5, further comprising a first urging member that urges the sheet guide in a first direction, which is from the second position toward the first position, when the sheet guide is located at the first position and that urges the sheet guide in a second direction, which is opposite to the first direction, when the sheet guide is located at a position closer to the second position than the position where the hook is disengaged is.

10. The sheet transport device according to claim 2, further comprising a restricting member, wherein
the hook is urged in a bending direction in which the claw-shaped other end is bent,
the other end is tapered toward the distal end, and
the restricting member restricts the position of the other end such that the distal end is located farther than the receiving part in a direction opposite to the bending direction until the other end comes into contact with the receiving part when the cover is closed.

11. The sheet transport device according to claim 1, further comprising a second contact part that comes into contact with the sheet guide located at the second position and applies a force toward the first position to move the sheet guide to the first position when the cover is closed.

12. The sheet transport device according to claim 11, wherein the second contact part stops being in contact with the sheet guide while the sheet guide moves from the first position to the second position.

13. The sheet transport device according to claim 11, further comprising a second urging member that urges the sheet guide in a first direction, which is from the second position toward the first position, when the sheet guide is located at the first position and that urges the sheet guide in a second direction, which is opposite to the first direction, when the sheet guide is located at a position where the sheet guide stops being in contact with the second contact part.

14. The sheet transport device according to claim 12, further comprising a second urging member that urges the sheet guide in a first direction, which is from the second position toward the first position, when the sheet guide is located at the first position and that urges the sheet guide in a second direction, which is opposite to the first direction, when the sheet guide is located at a position where the sheet guide stops being in contact with the second contact part.

15. The sheet transport device according to claim 1, wherein
the transport part includes a first rotary member, a second rotary member that rotates with the first rotary member to transport a sheet nipped therebetween, and a support member that supports the second rotary member while urging the second rotary member toward the first rotary member, and
the sheet guide includes a moving member that comes into contact with the support member and moves the support member in a direction in which the second rotary member moves away from the first rotary member when the sheet guide moves from the first position to the second position.

16. An image forming apparatus comprising:
a transport part that transports a sheet along a transport path;
a sheet guide that forms the transport path when located at a first position and that exposes the sheet in the transport path when located at the second position;
a housing that accommodates the transport part and the sheet guide;
a cover provided on the housing, the cover being capable of being opened and closed and being provided at a position where the cover covers the sheet guide;
a pulling member that is connected at one end to the cover and at the other end to the sheet guide located at the first position when the cover is closed, the pulling member pulling the sheet guide to the second position when the cover is opened; and
an image forming part that forms an image on the sheet transported by the transport part.

17. An image forming apparatus comprising:
transport means for transporting a sheet along a transport path;
a sheet guide that forms the transport path when located at a first position and that exposes the sheet in the transport path when located at the second position;
a housing that accommodates the transport part and the sheet guide;
a cover provided on the housing, the cover being capable of being opened and closed and being provided at a position where the cover covers the sheet guide;
a pulling member that is connected at one end to the cover and at the other end to the sheet guide located at the first position when the cover is closed, the pulling member pulling the sheet guide to the second position when the cover is opened; and
image forming means for forming an image on the sheet transported by the transport part.
